(19) United States
(12) Patent Application Publication
(10) Pub. No.: US 2012/0060640 A1
(43) Pub. Date: Mar. 15, 2012

(54) ZTR CONTROL HANDLE KNOBS

(76) Inventor: John H. Buford, Wentzville, MO (US)

(21) Appl. No.: 13/233,817

(22) Filed: Sep. 15, 2011

Related U.S. Application Data
(60) Provisional application No. 61/383,064, filed on Sep. 15, 2010.

(51) Int. Cl. B62D 1/12

(52) U.S. Cl. 74/544; 74/543

(57) ABSTRACT

A control handle knob assembly for use with a control handle of a ZTR vehicle. The knob assembly includes a control handle engagement portion having a clamping mechanism configured to fixedly engage the control handle of the ZTR vehicle. The assembly includes an extension portion having a support rod attached to the control handle engagement portion and a user interface portion having a rotating knob attached to the support rod at an end opposite control handle engagement portion. The knob is attached to allow free rotation of the knob about the support rod.

### RELATED APPLICATIONS

The present application claims priority to and benefit of U.S. Provisional Application 61/383,064, filed Sep. 15, 2010.

### BACKGROUND

The present invention generally relates to zero turn radius (ZTR) vehicles such as mowers, and more specifically to a control handle knob for a ZTR mower.

Vehicles such as mowers sometimes include drive systems having zero turning radius steering. Many ZTR vehicles have two drive wheels that can be rotated at different speeds and in different directions to achieve turning. The wheels of the ZTR vehicles are frequently controlled by a pair of control handles or arms, one of which extends upward on each side of an operator seat. Each of the control handles is independently operated to control the speed and direction of each wheel, and thus to control the speed and direction of the ZTR vehicle. Frequently, ZTR vehicles include an adjustable seat, adjustable armrests, and/or adjustable control handles so the operator can comfortably reach the control handles at all handle operating positions. Often the adjustable features are adjusted to set the control handles in a neutral position. However, when operating the control handles, a user usually must fully extend his arm and in some instances lean forward to move the control handles to their forward most position. Leaning forward can cause the operator fatigue and discomfort.

Adjusting the vehicle takes time, and this problem is compounded when the vehicle is used by more than one operator. Further, in some settings, operating manuals are lost or operators may be unable to read the manuals, preventing the operators from being instructed how to adjust the vehicle. Thus, there is a need for quickly and reliably adjusting ZTR vehicle controls to prevent operator fatigue and discomfort.

### SUMMARY

In one aspect, the present invention includes a control handle knob assembly for use with a control handle of a ZTR vehicle. The knob assembly comprises a control handle engagement portion comprising a clamping mechanism configured to fixedly engage the control handle of the ZTR vehicle. In addition, the knob assembly includes an extension portion comprising a support rod attached to the control handle engagement portion and a user interface portion comprising a rotating knob attached to the support rod at an end opposite control handle engagement portion. The knob is attached to allow free rotation of the knob about the support rod.

In another aspect, the present invention includes a kit comprising a pair of control handle knob assemblies for use with a control handle of a ZTR vehicle. Each knob assembly comprises a control handle engagement portion comprising a clamping mechanism configured to fixedly engage the control handle of the ZTR vehicle. Each knob assembly also includes an extension portion comprising a support rod attached at a first end to the control handle engagement portion and a user interface portion comprising a rotating knob attached to the support rod at an end opposite the first end of the support rod. The knob is attached to allow free rotation of the knob about the support rod.

In yet another aspect, the present invention includes a kit comprising a clamping mechanism configured to fixedly engage a control handle of a ZTR vehicle. The kit also includes a knob and a plurality of support rods of differing lengths. Each support rod comprises a first end configured for attachment to the clamping mechanism and a second end configured for attachment to the knob.

Other objects and features will be in part apparent and in part pointed out hereinafter.

### BRIEF DESCRIPTION OF THE DRAWINGS

FIG. 1 is a schematic illustration of a ZTR mower of the prior art;

FIG. 2 is a schematic illustration of a ZTR mower including a control handle knob assembly according to one embodiment of the present invention;

FIG. 3 is a side elevation of a control handle knob assembly according to one embodiment of the present invention; and

FIG. 4 is a perspective of a clamping mechanism according to a second embodiment of the present invention.

Corresponding reference characters indicate corresponding parts throughout the drawings.

### DETAILED DESCRIPTION

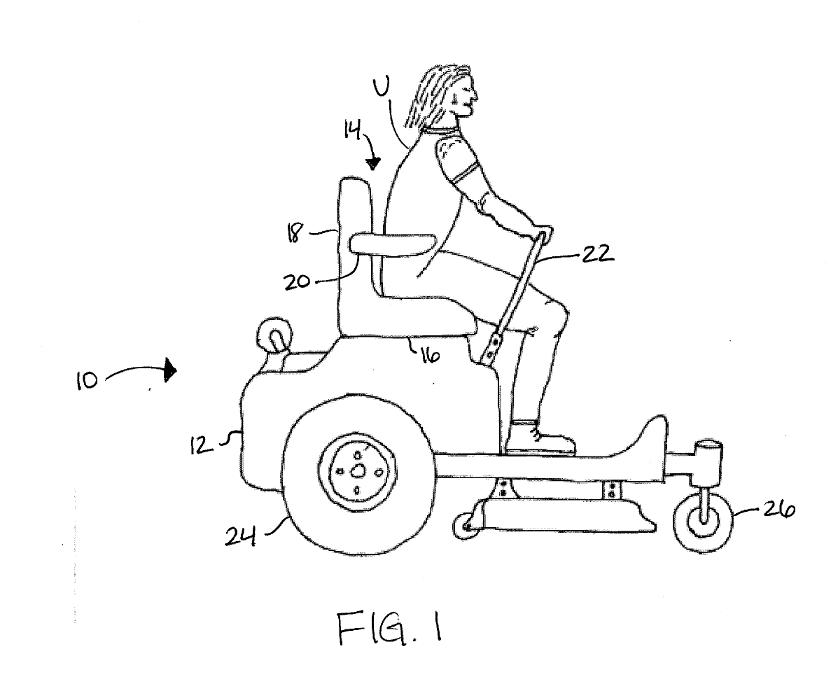

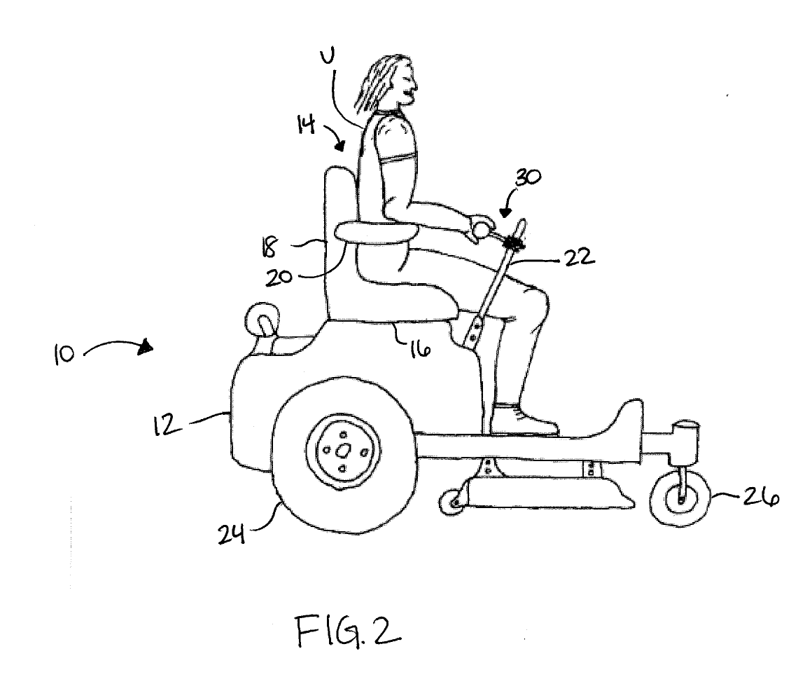

Referring generally to FIGS. 1 and 2, a vehicle comprising a ZTR vehicle is generally indicated at 10. As illustrated, the ZTR vehicle 10 includes body 12 having an adjustable operator station, generally designated by 14, having a seat 16, a back 18, and a pair of armrests 20 (only one of which is visible in the drawings). The ZTR vehicle 10 also includes a pair of control handles 22 (only one of which is visible in the drawings) that extend upward from the body 12 on opposite sides of the operator station 14. The ZTR vehicle 10 also includes standard features such as a motor (not shown) that drives a pair of drive wheels 24 and a cutting blade (not shown). A conventional transmission (not shown) operatively connects the motor to the drive wheels 24 so the wheels may be independently driven at different speeds and in different directions to turn the vehicle 10. Caster wheels 26, which pivot to follow the drive wheels 24, are also provided on the vehicle 10. As other features of the vehicle 10 are conventional, they will not be described in further detail.

FIG. 1 illustrates a ZTR vehicle 10 being operated without a control handle knob assembly according to the present invention. A user, designated U, must lean forward and extend his shoulder and arm to operate the control handles 22, such that his back is not resting against the back 18 of the operator station 14 and he is unable to use the armrests 20. The user U must assume this position in order to reach each control handle 22 to operate the vehicle 10, due to the position of the control handles with respect to the operator station 14. The position of the user U in FIG. 1 can cause fatigue and discomfort when the vehicle is operated for an extended period of time.

FIG. 2 illustrates the ZTR vehicle 10 in operation with a control handle knob assembly 30 according to the present invention. The user U is able to sit back in the adjustable operator station 14 such that his back is resting against the back 18 and his arm is resting on the armrest 20, while still manipulating each control handle 22 to operate the vehicle 10. Furthermore, his arm and shoulder need not be extended to operate the control handle 20 when a knob assembly 30 is attached to the control handle. Thus, operation of the vehicle 10 for any period of time is less likely to cause stress, fatigue, and discomfort to the user U. The user U can assume a more relaxed position and avoid stressing his back, shoulders, arms, and hands.

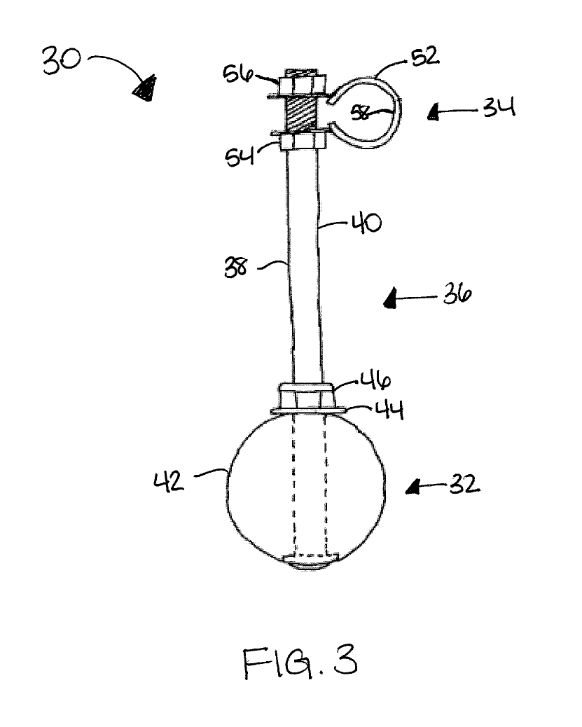

Referring now to FIG. 3, the control handle knob assembly 30 includes a user interface portion 32 that the user U grips to operate the control handle 20 of the vehicle 10, a control handle engagement portion 34 that attaches the knob assembly to the control handle, and an extension portion 36 extending between the user interface portion and the control handle engagement portion. The extension portion 36 includes a support rod or tube 38. The extension portion can be offered in different lengths according to user necessity based on comfort level, arm length, and mower configuration. For example, the extension portion 36 can be offered in a range of 1-8 inches. The support rod 38 can be made of metal or any other suitable material known in the art. In some embodiments, the support rod 38 is threaded as will be described below. A central portion 40 of the support rod 38 is covered in material, such as soft vinyl or rubber, to protect the user from the threaded support rod and to provide an aesthetically pleasing appearance. The support rod 38 may have other configurations without departing from the scope of the present invention. For example, the support rod 38 may have a different shape, or be only partially threaded. In one embodiment, multiple support rods 38 of differing lengths can be provided with one knob assembly 30 to accommodate user needs.

The user interface portion 32 includes a knob or handle 42 attached to the support rod 38 at a first end. The knob 42 is held in place by a washer 44 and a locking nut, such as a hex nut 46, threaded on the support rod 38. The knob 42 is held in position on the support rod 38. In some embodiments, the knob 42 can freely rotate to provide maximum comfort and control to the user U. Because the knob 42 can freely rotate, the user can position his hands freely on the knob, in contrast to some steering wheel or spinner knobs that require the user's hands remain in a fixed position. In the illustrated embodiment, the knob 42 is in the shape of a round ball. For gripping ease, the round ball can have a diameter in a range of 1-4 inches. The knob 42 can also have other shapes according to user preferences, such as egg, oval, tube, or handle shapes. The knob 42 can be made of any suitable material known in the art, such as wood, plastic, rubber, aluminum, or other metal, depending on user preferences and the shape of the knob. The knob 42 can also be decorated or colored or otherwise made aesthetically pleasing to the user.

Attached to the support rod 38 on a second end opposite the first end with the knob 42 is the control handle engagement portion 34. The control handle engagement portion 34 is configured to engage the control handle 22 and includes a clamping mechanism. The clamping mechanism comprises a ring or band 52 that is clamped around a gripping portion of the control handle 22. The ring 52 is clamped between a first nut, such as a ⅜ hex nut 54 and a second nut, such as a ⅜ hex nut 56, threaded on the support rod 38. The nuts 54, 56 can be welded or bonded to the mounting bracket. The ring or band 52 can be made of metal or any other suitable material, and can include a plastic insert, such as a PVC insert 58, to provide a tight, slip resistant connection to the control handle 22. The PVC insert 58 also protects the control handle 22 from damage caused by the metal ring 52. The ring 52 can be clamped to accommodate a range of control handle sizes. For example, the ring 52 can vary in diameter from 0.5-1.5 inches upon applying different clamping forces. Alternative clamping configurations may be used without departing from the scope of the present invention. For example, the ring or band may be clamped by a combination of one or more bolts, nuts, or washers, or two half rings or half bands may be clamped by the combination of one or more bolts, nuts, or washers. In other embodiments, the support rod 38 does not have to comprise part of the clamping mechanism.

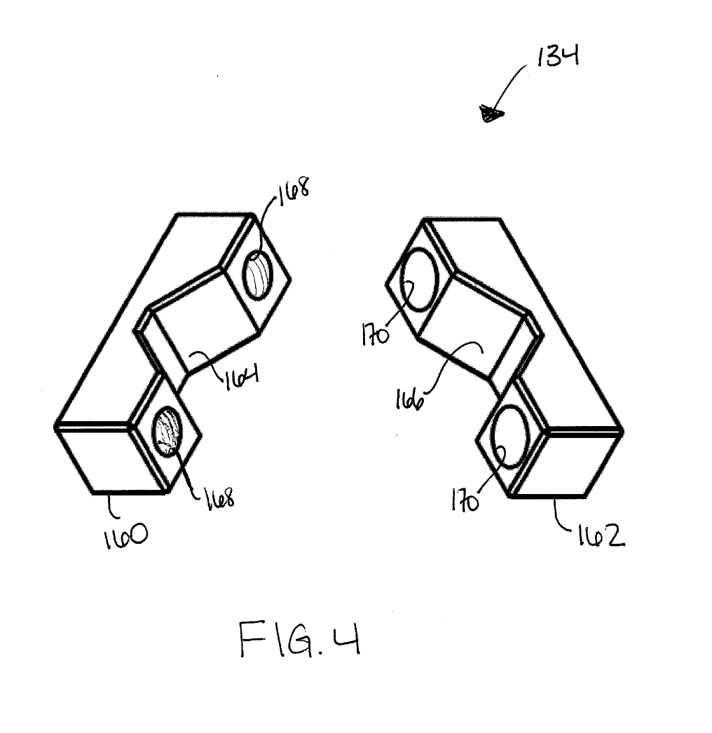

FIG. 4 illustrates a second embodiment of a control handle engagement portion 134. In this embodiment, the mounting bracket includes a clamping mechanism having a first component 160 and a second component 162 configured to engage the control handle 22 between them by clamping around the control handle. As illustrated, the first and second components 160, 162 of the clamping mechanism are blocks (e.g., metal blocks) having V-notches 164 and 166, respectively. The V-notches 165, 166 are configured to receive varying sizes of control handles 22. For example, the V-notches can be sized and shaped to receive a control handle 22 of any size in the range of 0.75-0.875 inches. Metal blocks having different sizes can be provided for different sized control handles 22.

The first metal block 160 includes two threaded holes 168, and the second metal block 162 includes two through holes 170. The holes 168 extend through the entire depth of the metal block 160 and are located on either side of the V-notch 164. Likewise, the holes 170 extend through the entire depth of the metal block 162 and are located on either side of the V-notch 166. In use, the control handle 22 is received between the metal blocks 160, 162 in the V-notches 164, 166. The metal blocks are compressed or clamped together around the control handle 22 by a bolt (not shown) extending through one set of corresponding holes 168, 170, and the support rod 38 extending through the other set of corresponding holes 168, 170. Thus, the knob assembly is securely and fixedly but removably attached to the control handle 22. Other clamping mechanisms for fixedly attaching the knob assembly to the control handle are within the scope of the present invention.

As mentioned above, ZTR vehicles typically include two control handles 22. Accordingly, the knob assembly 30 can be sold in pairs, so that each control handle 22 has a corresponding knob assembly 30, thereby ensuring comfort for the user. The knob assembly 30 can also be sold in a disassembled kit including a user interface portion 32, a control handle engagement portion 34, and multiple extension portions 36 of varying lengths. A kit of this kind allows a user to change the support rods 38 to obtain the most comfortable fit based on the user's physical characteristics and the configuration of the ZTR vehicle 10. Because there are two control handles 22, the disassembled kit in one embodiment includes two of each piece. In a similar manner, multiple rings or sets of metal blocks can be provided to ensure that a snug fit to the ZTR control handle 22 is achieved.

Having described the invention in detail, it will be apparent that modifications and variations are possible without departing from the scope of the invention defined in the appended claims.

When introducing elements of the present invention or the preferred embodiments(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that the several objects of the invention are achieved and other advantageous results attained.

As various changes could be made in the above products without departing from the scope of the invention, it is intended that all matter contained in the above description and shown in the accompanying drawings shall be interpreted as illustrative and not in a limiting sense.

What is claimed is:

1. A control handle knob assembly for use with a control handle of a ZTR vehicle, the knob assembly comprising:
a control handle engagement portion comprising a clamping mechanism configured to fixedly attach the control handle of the ZTR vehicle;
an extension portion comprising a support rod attached to the control handle engagement portion; and
a user interface portion comprising a rotating knob attached to the support rod at an end opposite control handle engagement portion, the knob being attached to allow free rotation of the knob about the support rod.

2. The control handle knob assembly of claim 1, wherein the rotating knob is attached to the support rod by a washer and a locking nut threaded on the support rod.

3. The control handle knob assembly of claim 1, wherein the clamping mechanism comprises a ring configured to receive the control handle and first and second nuts threaded on the support rod, the ring being attached to the nuts and thereby tightened or loosened by movement of the nuts relative to each other along the support rod.

4. The control handle knob assembly of claim 3, further comprising a plastic insert attached on an inner surface of the ring to provide a tight connection between the ring and the control handle.

5. The control handle knob assembly of claim 1, wherein the clamping mechanism comprises a first block having a first threaded hole and a second threaded hole and a second block having a first through hole and a second through hole, the first and second blocks being configured to receive the control handle therebetween.

6. The control handle knob assembly of claim 5, wherein the clamping mechanism further comprises a bolt configured to extend through the first through hole and engage the first threaded hole, the support rod being attached to the control handle engagement portion by extending through the second through hole and engaging the second threaded hole, wherein the control handle is fixedly and securely clamped between the first and second blocks by moving the first and second blocks relative to each other along the bolt and the support rod.

7. The control handle knob assembly of claim 1, wherein the knob comprises a sphere having a diameter in the range of 1 to 4 inches.

8. The control handle knob assembly of claim 1, wherein the knob is made of plastic.

9. The control handle knob assembly of claim 1, wherein the support rod has a length in the range of 1 to 8 inches.

10. A kit comprising:
a pair of control handle knob assemblies for use with a control handle of a ZTR vehicle, each knob assembly comprising:
a control handle engagement portion comprising a clamping mechanism configured to fixedly engage the control handle of the ZTR vehicle;
an extension portion comprising a support rod attached at a first end to the control handle engagement portion; and
a user interface portion comprising a rotating knob attached to the support rod at an end opposite the first end of the support rod, the knob being attached to allow free rotation of the knob about the support rod.

11. A kit comprising:
a clamping mechanism configured to fixedly engage a control handle of a ZTR vehicle;
a knob; and
a plurality of support rods of differing lengths, each support rod comprising a first end configured for attachment to the clamping mechanism and a second end configured for attachment to the knob.

12. The kit of claim 11, wherein each support rod is configured such that the knob is attached to a selected support rod by a washer and a locking nut threaded on the selected support rod.

13. The kit of claim 11, wherein the clamping mechanism comprises a ring configured to receive the control handle and first and second nuts configured to be threaded on each of the support rods, the ring being attached to the nuts and thereby tightened or loosened by movement of the nuts relative to each other along a selected support rod.

14. The kit of claim 13, further comprising a plastic insert attached on an inner surface of the ring to provide a tight connection between the ring and the control handle.

15. The kit of claim 11, wherein the clamping mechanism comprises a first block having a first threaded hole and a second threaded hole and a second block having a first through hole and a second through hole, the first and second blocks configured to receive the control handle therebetween.

16. The kit of claim 15, wherein the clamping mechanism further comprises a bolt configured to extend through the first through hole and engage the first threaded hole, each of the support rods being configured for attachment to the control handle engagement portion by extending through the second through hole and engaging the second threaded hole, wherein the control handle is fixedly and securely clamped between the first and second blocks by moving the first and second blocks relative to each other along the bolt and a selected support rod.

17. The kit of claim 11, wherein the knob comprises a round ball having a diameter in the range of 1 to 4 inches.

18. The kit of claim 11, wherein the knob is made of plastic.

19. The kit of claim 11, wherein the plurality of support rods each have a different length in the range of 1 to 8 inches.

20. The kit of claim 11, further comprising:
a second clamping mechanism configured to fixedly engage a second control handle of the ZTR vehicle;
a second knob; and
a second plurality of support rods of differing lengths, each support rod comprising a first end configured for attachment to the second clamping mechanism and a second end configured for attachment to the second knob, the second knob being attached to allow free rotation of the second knob about the support rod.
